(19) United States
(12) Patent Application Publication
(10) Pub. No.: US 2026/0264652 A1
(43) Pub. Date: Sep. 10, 2026

(54) PNEUMATIC LINE SWITCHING SYSTEM

(71) Applicant: ELECTRANS TECHNOLOGIES LTD., Toronto (CA)

(72) Inventors: Brian LAYFIELD, Toronto (CA); Brian FAN, Toronto (CA); Brian Quinn KETTLEWELL, Toronto (CA); Josip BALABAN, Toronto (CA); Karan SETHY, Toronto (CA); Edward Joseph ECCLESTONE, Toronto (CA)

(21) Appl. No.: 19/559,536

(22) Filed: Mar. 6, 2026

Related U.S. Application Data
(60) Provisional application No. 63/768,646, filed on Mar. 7, 2025.

(51) Int. Cl. B60T 13/36; B60T 17/04

(52) U.S. Cl. CPC B60T 13/36; B60T 17/043; B60Y 2200/148

(57) ABSTRACT

Disclosed herein is a pneumatic line switching system, wherein when a first braking system air-piloted pneumatic valve is in a first pneumatic valve state and a first braking system first output connector of the first braking system air-piloted pneumatic valve is coupled to a first type of braking system interface connector, a first braking system pneumatic valve line input of the first braking system air-piloted pneumatic valve is in fluid communication with a respective pneumatic output connector of the first type of braking system interface connector, and when the first braking system air-piloted pneumatic valve is in a second pneumatic valve state and a first braking system second output connector is coupled to a second type of braking system interface connector, the first braking system pneumatic valve line input is in fluid communication with a respective pneumatic output connector of the second type of braking system interface connector.

### RELATED APPLICATIONS

This application claims benefit of U.S. Provisional Patent Application Ser. No. 63/768,646, filed Mar. 7, 2025, which is incorporated herein by reference in its entirety.

### FIELD OF THE INVENTION

This disclosure relates generally to the road transportation industry. More specifically, the disclosure is directed at a switching system for switching between alternative pneumatic systems of a towing vehicle and a trailer.

### BACKGROUND

In regular heavy-duty commercial trucking operations, a towing vehicle such as a yard shifter or tractor will interface may need to couple with trailers that have different types of pneumatic interface connections. For example, some trailers may have traditional ‘gladhand’ style pneumatic connectors. As known in the art, a gladhand connector or gladhand coupler is an interlocking hose coupling fitted to hoses supplying pressurized air from a tractor unit to air brakes on a semi-trailer. Some trailers, however, may instead be equipped with contemporary electro-pneumatic interface (EPI) style receptacle connectors, which have both electrical and pneumatic connections within the same housing.

Accordingly, there is a need for a configuration that will allow a towing vehicle to efficiently be coupled to a trailer that includes gladhand style pneumatic connections or, alternatively, EPI style connector receptacle, when such a type of connection is available.

### BRIEF DESCRIPTION OF DRAWINGS

In the figures, which illustrate example embodiments,

FIG. 1 is a schematic view showing a towing vehicle and a trailer equipped with a pneumatic line switching system according to example embodiments.

FIG. 2 is a front view of the pneumatic line switching system of FIG. 1.

FIG. 3 is a schematic line drawing of the pneumatic line switching system of FIG. 2.

FIG. 4 is a perspective view showing part of a trailer with both Gladhand and EPI connectors that can be connected to a tractor equipped with the pneumatic line switching system of FIG. 2.

### DETAILED DESCRIPTION

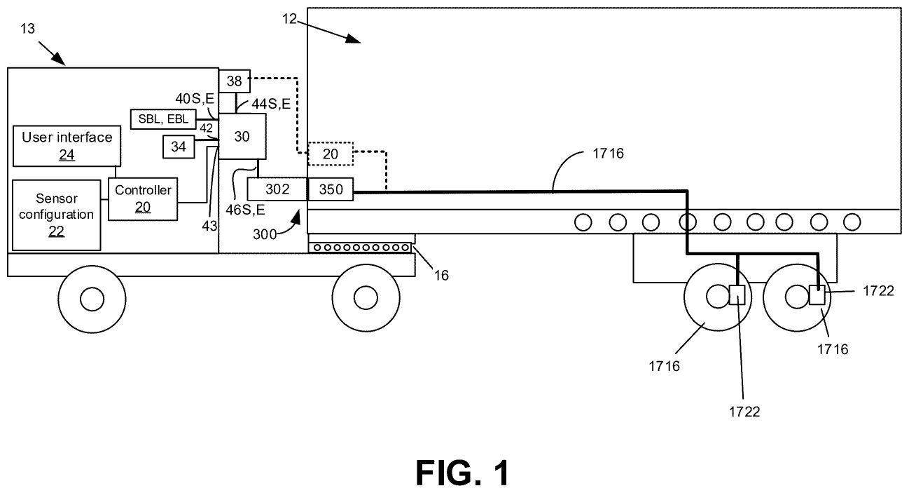

FIG. 1 depicts a towing vehicle 13 that is coupled to a vehicle connector, for example a trailer 12. The towing vehicle 13 is configured to tow the trailer 12. In some embodiments, for example, the towing vehicle 13 is a tractor, a yard shifter, or a converter dolly. In some embodiments, for example, the towing vehicle 13 is an autonomous vehicle, such as an autonomous tractor, yard shifter, or converter dolly. In some embodiments, for example, the towing vehicle 13 includes a fifth wheel assembly 16 configured for slidably receiving, and coupling with a corresponding kingpin of the trailer 12.

In the illustrated example, towing vehicle 13 includes an on-board vehicle controller 20 that is operably connected to a set or electrical or electromechanical components of the vehicle 13, including for example a sensor configuration 22, and a user interface 24 (e.g., a human machine interface (HMI)). The vehicle controller 20 can, for example, include a processor or a central processing unit (CPU), a memory such as a ROM, RAM, persistent memory, or flash memory for storing data, and input or output peripherals. In some embodiments, for example, the vehicle controller 20 acts as a central controller for controlling various components and devices of vehicle 13 and the trailer 12.

The trailer 12 includes a running gear with wheels 1716, and a braking system that include brakes 1722 operably coupled to the wheels 1716 for applying a braking force to the wheels 1716. The brakes 1722, commonly referred to as airbrakes, are operably coupled to one or more pneumatic lines 1716 that supply pneumatic pressure to cause breaks to apply the breaking force. Pneumatic lines 1716 can, for example, include service brake and emergency brake lines. When vehicle 13 and trailer 12 are coupled together, pneumatic lines 1716 are operably coupled to service break lines (SBL) and emergency break lines (EBL) of the vehicle by way of a pneumatic line interface system.

In some examples, the pneumatic lines 1716 of the trailer braking system are provided with a contemporary trailer mounted electro-pneumatic interface (EPI) connector 350 that includes an interface assembly that integrates a set of electrical, pneumatic and vehicle network bus connectors in such a manner as to allow efficient and reliable connection to a counterpart vehicle EPI connector 302. In some examples, the pneumatic lines 1716 of the trailer braking system are provided with a legacy trailer mounted gladhand pneumatic line connector interface 20 that includes a pneumatic gladhand connector for connection to a counterpart vehicle-mounted gladhand connector 38. In some examples, trailer 12 may include both an EPI connector 350 and a gladhand connector 20.

In the illustrated example, vehicle 13 includes a pneumatic line switching system 30 that is configured to enable the vehicle service break lines (SBL) and emergency break lines (EBL) to be selectively coupled, from a remote location, to two different types of trailer pneumatic line connectors that are provided on vehicle 13, for example, a gladhand style pneumatic connector 38, or an electro-pneumatic interface (EPI) style connector 302. This can enable the vehicle 13 to be easily coupled to trailers 12 that include one or the other of gladhand style pneumatic connectors 20 or EPI style connectors 350. Furthermore, in cases where a trailer 12 includes both gladhand connectors 20 and EPI connectors 350, the pneumatic line switching system 30 can allow both the vehicle braking system 1716 to be physically connected to the vehicles SBL and EBL systems through both gladhand connectors 20 and EPI connectors 350 to support operational redundancy in the event one of the systems fails.

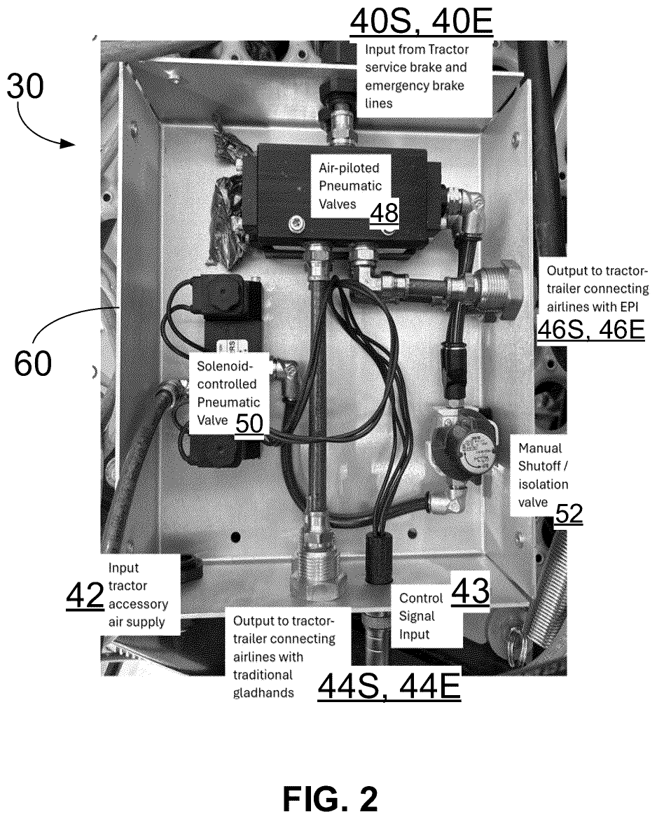

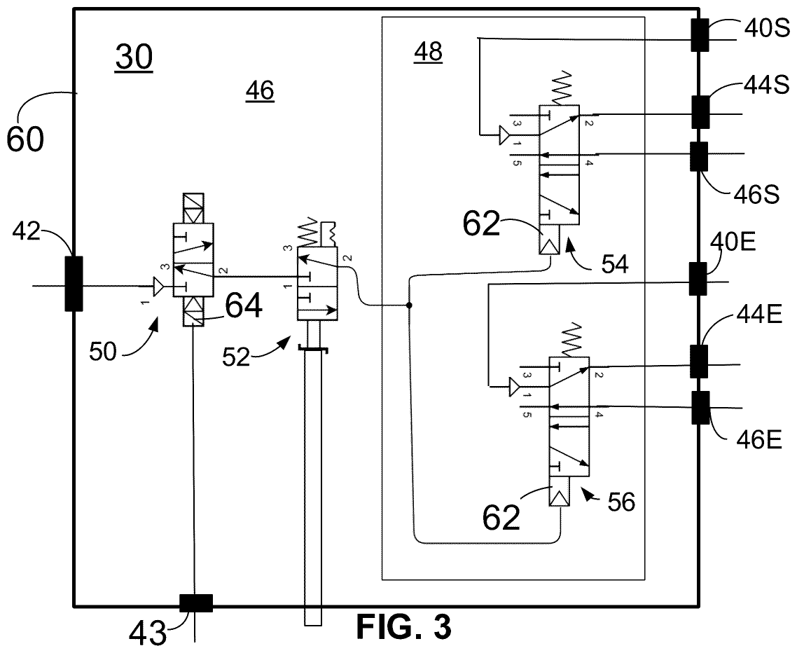

An example embodiment of pneumatic line switching system 30 will now be described in greater detail with reference to FIGS. 2 and 3.

As shown in FIG. 2, the pneumatic line switching system 30 can include a set of electro-mechanical and mechanical switching components that are housed within a rigid weather protective housing or enclosure 60, which may for example be mounted to or within the vehicle 13. These components can be located within an internal region defined by the enclosure 60 and themselves each be packaged within respective weather resistant housings that are mounted, together with supporting fluid connecting lines, within the enclosure 60. These components can include: a set of air-piloted pneumatic valves 48; a solenoid controlled pneumatic valve 50 that is coupled, through a manual shutoff/isolation valve 52, to control the air-piloted pneumatic valves 48. The solenoid controlled pneumatic valve 50 can have an electrical control line input that can be coupled to vehicle controller 20 to receive control inputs. The enclosure 60 can have one or more walls that define ports for and provide external connection by respective connectors to: pneumatic valve line input connectors 40S, 40E for the vehicle service break lines (SBL) and emergency break lines (EBL); pneumatic valve line SBL and EBL output connectors 44S, 44E for connecting to corresponding gladhand connectors of the gladhand style pneumatic connector 38; pneumatic valve line SBL and EBL output connectors 46S, 46E for connecting to corresponding connectors of the EPI connector 302; a control valve pneumatic line input connector 42 for connecting to a pressurized air reservoir 34 of the vehicle 13; and an electrical control line connector 43 for connecting to a controller 20 of the vehicle 13.

With reference to the schematic diagram of FIG. 3, the components of pneumatic line switching system 30 will now be described in greater detail. In the illustrated example, the set of air-piloted pneumatic valves 48 includes: (a) a first braking system air-piloted pneumatic valve 54 that is used for vehicle service break line (SBL) control a second braking system air-piloted pneumatic valve 56 that is used for vehicle emergency break line (EBL) control.

SBL system valve 54 includes a line input (line 1), a first pneumatic line output (line 2), a second pneumatic line output (line 4), and a pneumatic control input 62. The SBL system Valve 54 is selectively actuatable by pneumatic control inputs provided through its control input 62 to switch between a first pneumatic valve state in which the line input (line 1) is in fluid communication with the first pneumatic line output (line 2), and a second pneumatic valve state in which the line input (line 1) is in fluid communication with the second pneumatic line output (line 4). The solenoid controlled pneumatic control valve 50 includes a control valve pneumatic line input (line 1) and a control valve pneumatic line output (line 2). The pneumatic control valve 50 pneumatic line output (line 2) is operably coupled, through manual shutoff/isolation valve 52 to the SBL system valve 54 pneumatic control input 62 to provide the pneumatic control inputs. The solenoid controlled pneumatic valve 50 is responsive to a solenoid control input signal applied to its control terminals 64 to switch between a first control valve state in which the control valve pneumatic line input (line 1) is in fluid communication with the control valve pneumatic line output (line 2) and a second control valve state in which the control valve pneumatic line input (line 1) is isolated from the control valve pneumatic line output (line 2).

The SBL gladhands output connector 44S is in fluid communication with the first SBL pneumatic line output (line 2, valve 54). The EPI output connector 46S is in fluid communication with the second SBL pneumatic line output (line 4, valve 54).

The SBL braking system air-piloted pneumatic valve 54, gladhands output connector 44S and EPI output connector 64S are configured such that when the SBL valve 54 is in the first pneumatic valve state and the gladhands output connector 44S is coupled to gladhands interface connector 38, the SBL valve 54 line input 40S is in fluid communication with a respective SBL gladhands connector of the gladhands interface connector 38, and when the SBL valve 54 is in the second pneumatic valve state and the EPI output connector 46S is coupled to EPI interface connector 302, the SBL valve line input 40S is in fluid communication with a respective SBL output connector of the EPI interface connector 302.

The air-piloted pneumatic valve 56 that is used for vehicle emergency break line (EBL) control can function in an identical manner, and be actuated between the first and second states, with, the SBL braking system air-piloted pneumatic valve 54.

The manual shutoff/isolation valve 52 provides coupling of the control valve pneumatic line output (line 2) of the solenoid controlled pneumatic control valve to both the SBL valve 54 control input 62 and the EBL valve 56 control input 62 such that the operable coupling can be terminated by a manual input. In example implementations, SBL valve 54 and are each biased into their respective first states. Thus, in the absence of a pneumatic valve control input that forces the valves 54, 56 into their second states, the default brake system connection will be the gladhand system connection. Thus, closing the manual shutoff/isolation valve 52 will cause the system to default to the gladhand system connection.

In some examples, the solenoid controlled pneumatic control valve 50 is bistable such that the solenoid controlled pneumatic control valve is configured to stably remain in a current state even when power for providing the solenoid control input signal is terminated.

In summary, in FIG. 3, the leftmost line (line 1, solenoid valve 50) is the input from the tractor brake reservoir, which has as its air source is the primary brake reservoir. That solenoid valve 50 is a bistable solenoid, and it remains in any given state unless switched by the corresponding solenoid, so if electrical power is lost, it still remains in the current state.

Valve 52 is the manual shutoff/isolation valve shown in the off/exhausted position. In this state, the rest of the vehicle is isolated from this system and the pilot line is exhausted to atmosphere, so off. When the system is operating normally, ports 1 and 2 of valve 52 are in pneumatic communication and the state of the line is determined by the first solenoid. The remaining two valves are 54 and 56 are pneumatically piloted spring return valves. One for each of emergency brake and service brake pneumatic circuits. Valve 54 and 56 inputs 1 can in some examples be from the tractor, what would normally run to the lines with gladhands for connection to the trailer 13. Valve 54 and 56 outputs 2 are for the traditional service gladhand and emergency gladhand lines. Valve outputs 54 and 56 are routed to the service and emergency lines of the EPI interface connector.

In this regard, pneumatic line switching system 30 is capable of switching air supply automatically between gladhands and EPI and back. Operation requires less time than the retrieval process of an EPI plug. There is a manual override system via manual shutoff/isolation valve 52 to allow a driver to revert to gladhand operation only. The pneumatic line switching system 30 can be configured to be operable within the vehicle 13 (e.g., tractor) brake operation pressure range (60 PSI-120 PSI). The pneumatic line switching system 30 can furnish redundancy to prevent switching to EPI circuit at any time other than just after an EPI connection to prevent either lockup or loss of service brake function of the trailer.

Electrical is vehicle battery voltage, data supply is based on EPI connection sensing circuitry. The BLS uses air-actuated externally piloted solenoids as its primary switching component. A single 3/2 electrically driven, spring return, normally closed solenoid drives the entire system. Air from the main tank 1 of the tractor is used to actuate the shuttles within the two externally piloted 5/2 solenoid valves. This separates the braking lines from the solenoid switching lines, ensuring that under rapid brake deployment the system remains ‘latched’ onto the current state.

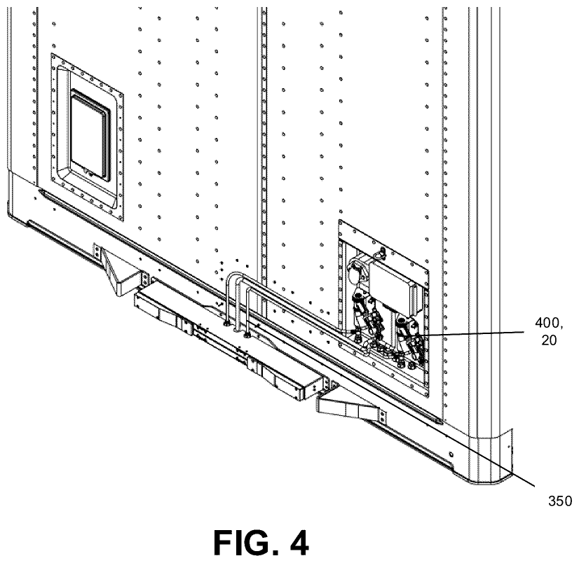

FIG. 4 shows a traditional nose box assembly 40, which would be mounted to a recess in the front of a trailer. Shown are gladhand connectors 20, 7-way connector, and accessory plug connector. A cartridge style EPI assembly supporting an EPI connector 350 is also shown. An example of an EPI system that example embodiments disclosed herein can work with is disclosed in PCT/CA 2025/050290, Filed Mar. 3, 2025, the contents of which are incorporated herein by reference.

1. A pneumatic line switching system, comprising:
a first braking system air-piloted pneumatic valve comprising a first braking system pneumatic valve line input, a first braking system first pneumatic line output, a first braking system second pneumatic line output, and a first braking system pneumatic valve control input, the first braking system air-piloted pneumatic valve being selectively actuatable by pneumatic control inputs provided through the first braking system pneumatic valve control input to switch between a first pneumatic valve state in which the first braking system pneumatic valve line input is in fluid communication with the first braking system first pneumatic valve line output, and a second pneumatic valve state in which the first braking system pneumatic valve line input is in fluid communication with the first braking system second pneumatic valve line output;
a solenoid controlled pneumatic control valve comprising a control valve pneumatic line input and a control valve pneumatic line output operably coupled to the first braking system pneumatic valve control input of the first braking system air-piloted pneumatic valve to provide the pneumatic control inputs, the solenoid controlled pneumatic valve being responsive to a solenoid control input signal to switch between a first control valve state in which the control valve pneumatic line input is in fluid communication with the control valve pneumatic line output and a second control valve state in which the control valve pneumatic line input is isolated from the control valve pneumatic line output;
a first braking system first output connector in fluid communication with the first braking system first pneumatic line output;
a first braking system second output connector in fluid communication with the first braking system second pneumatic line output;
the first braking system air-piloted pneumatic valve, first braking system first output connector and first braking system second output connector being cooperatively configured such that when the first braking system air-piloted pneumatic valve is in the first pneumatic valve state and the first braking system first output connector is coupled to a first type of braking system interface connector, the first braking system pneumatic valve line input is in fluid communication with a respective pneumatic output connector of the first type of braking system interface connector, and when the first braking system air-piloted pneumatic valve is in the second pneumatic valve state and the first braking system second output connector is coupled to a second type of braking system interface connector, the first braking system pneumatic valve line input is in fluid communication with a respective pneumatic output connector of the second type of braking system interface connector.

2. The pneumatic line switching system of claim 1, further comprising:
a second braking system air-piloted pneumatic valve comprising a second braking system pneumatic valve line input, a second braking system first pneumatic line output, a second braking system second pneumatic line output, and a second braking system pneumatic valve control input also operably coupled to the control valve pneumatic line output of the solenoid controlled pneumatic control valve to receive the pneumatic control inputs, the second braking system air-piloted pneumatic valve being selectively actuatable by the pneumatic control inputs to switch between a first pneumatic valve state in which the second braking system pneumatic valve line input is in fluid communication with the second braking system first pneumatic valve line output, and a second pneumatic valve state in which the second braking system pneumatic valve line input is in fluid communication with the second braking system second pneumatic valve line output;
a second braking system first output connector in fluid communication with the first braking system first pneumatic line output;
a second braking system second output connector in fluid communication with the first braking system second pneumatic line output;
the second braking system air-piloted pneumatic valve, second braking system first output connector and second braking system second output connector being cooperatively configured such that when the second braking system air-piloted pneumatic valve is in the first pneumatic valve state and the second braking system first output connector is coupled to the first type of braking system interface connector, the second braking system pneumatic valve line input is in fluid communication with a respective pneumatic output connector of the first type of braking system interface connector, and when the second braking system air-piloted pneumatic valve is in the second pneumatic valve state and the second braking system second output connector is coupled to the second type of braking system interface connector, the second braking system pneumatic valve line input is in fluid communication with a respective pneumatic output connector of the second type of braking system interface connector.

3. The pneumatic line switching system of claim 2, further comprising a manually activated isolation valve, wherein the operable coupling of the control valve pneumatic line output of the solenoid controlled pneumatic control valve to both the first braking system pneumatic valve control input and the second braking system pneumatic valve control input is provide through the through the manually activated isolation valve such that the operable coupling can be terminated by a manual input.

4. The pneumatic line switching system of claim 1, further comprising a rigid enclosure,
the enclosure defining an internal region containing:
the first braking system air-piloted pneumatic valve;
the solenoid controlled pneumatic control valve; and
the second braking system air-piloted pneumatic valve,
and the enclosure having one or more walls that define ports for and provide external connection by respective connectors to:
a first braking system pneumatic valve line input connector that is in fluid communication with the first braking system pneumatic valve line input;
the first braking system first output connector;
the first braking system second output connector;
the second braking system first output connector;
the second braking system second output connector; and
a control valve pneumatic line input connector.

5. The pneumatic line switching system of claim 1, wherein the solenoid controlled pneumatic control valve is bistable such that the solenoid controlled pneumatic control valve is configured to stably remain in a current state even when power for providing the solenoid control input signal is terminated.

6. The pneumatic line switching system of claim 1, wherein the first braking system air-piloted pneumatic valve is configured to be biased into the first pneumatic valve state thereof in the absence of a pneumatic valve control input that forces the first braking system air-piloted pneumatic valve into the second pneumatic valve state thereof.

7. The pneumatic line switching system of claim 2, wherein the second braking system air-piloted pneumatic valve is configured to be biased into the first pneumatic valve state thereof in the absence of a pneumatic valve control input that forces the second braking system air-piloted pneumatic valve into the second pneumatic valve state thereof.

8. The pneumatic line switching system of claim 1, wherein the first braking system is a service brake system for a trailer.

9. The pneumatic line switching system of claim 2, wherein the second braking system is an emergency brake system for a trailer.

10. The pneumatic line switching system of claim 1, wherein the first type of braking system interface connector is a gladhands interface connector.

11. The pneumatic line switching system of claim 1, wherein the second type of braking system interface connector is an electro-pneumatic interface connector wherein electrical, network bus and pneumatic line connectors are provided within a common connection assembly.

12. A towing vehicle comprising:
the pneumatic line switching system of claim 1;
a controller operatively connected to the solenoid controlled pneumatic control valve to provide the solenoid control input signal;
the first type of braking system interface connector, wherein a pneumatic line of the towing vehicle couples the pneumatic output connector of the first type of braking system interface connector to its respective first braking system first output connector, the pneumatic output connector being a gladhands style connector; and
the second type of braking system interface connector, wherein a further pneumatic line of the towing vehicle couples the pneumatic output connector of the second type of braking system interface connector to its respective second braking system first output connector, the pneumatic output connector being housed within an electro-pneumatic interface connector.
